(19) United States
(12) Patent Application Publication
(10) Pub. No.: US 2010/0198414 A1
(43) Pub. Date: Aug. 5, 2010

(54) SYSTEMS AND METHODS FOR CONTROLLING INTERIOR CLIMATES

(76) Inventors: Steven C. Kroll, Evergreen, CO (US); John W. Andrews, Idaho Springs, CO (US)

Correspondence Address: MARSH, FISCHMANN & BREYFOGLE LLP, 8055 East Tufts Avenue, Suite 450, Denver, CO, 80237, US

(21) Appl. No.: 12/651,381

(22) Filed: Dec. 31, 2009

Related U.S. Application Data
(63) Continuation-in-part of application No. 11/770,152, filed on Jun. 28, 2007.

(51) Int. Cl. G05B 15/00; F24D 3/16

(52) U.S. Cl. 700/278; 165/56

(57) ABSTRACT

Structural wall panels and methods and systems for controlling the interior temperature of a building are provided. The structural wall panels advantageously include a fluid conduit disposed within an interior concrete layer of the structural wall panel where the conduit is adapted to convey a thermal transfer fluid through the interior concrete layer. A thermal insulation layer may be provided between the first concrete layer and an exterior surface of the wall. The thermal transfer fluid can be heated and/or cooled to regulate the temperature of the interior concrete layer and thereby control the temperature of the interior of the building. The interior concrete layer may have a high thermal mass to increase the thermal efficiency of the system.

### CROSS-REFERENCE TO RELATED APPLICATIONS

This application is a continuation-in-part application of U.S. patent application Ser. No. 11/770,152, filed on Jun. 28, 2007, which is incorporated herein by reference in its entirety.

### BACKGROUND OF THE INVENTION

1. Field of the Invention

The present invention relates to systems and methods for controlling the interior climate within a building structure, such as by adjusting the temperature within the building structure. More particularly, the present invention relates to systems and methods for the regulation of the temperature within a building structure by moving a thermal transfer fluid such as water through the walls and/or ceilings of the building structure.

2. Description of Related Art

One of the most significant uses of energy is directed to maintaining a comfortable climate within residential or commercial building structures. Rising energy costs have necessitated the development of low-energy solutions for climate control within the interior of a building. Further, the environmental hazards associated with modern energy production, such as the generation of greenhouse gases, has led to the desire to fabricate buildings having a reduced carbon footprint, i.e., buildings that consume less energy for construction and less energy for day-to-day living.

It has been suggested to provide heating by use of a thermal transfer fluid, such as air or water. For example, U.S. Pat. No. 4,000,850 by Diggs discloses a modular building that includes insulated, prefabricated wall and roof panels supported on tubular wall columns and roof beams. Fluid circulating means is connected with the tubular wall columns and roof beams to circulate fluid therethrough at a desired temperature to maintain a desired temperature in the building. Solar panels can be supported on the roof of the building for heating a fluid and providing the heated fluid to a heat pump, which is used to heat or cool a fluid that is circulated through the tubular wall columns and roof beams.

U.S. Pat. No. 4,442,826 by Pleasants discloses a passive solar device comprising a pre-cast construction panel that is useful for the construction of buildings. The panel includes an internal, concealed containment element for the storage and circulation of a thermally efficient fluid, such as water. The fluid-filled containment element serves as a core around which cementitious material, such as concrete, is placed. To facilitate thermal fluid flow, the device includes top and bottom nipples to facilitate connection of the device with other system elements.

U.S. Pat. No. 4,295,415 by Schneider, Jr. discloses an environmentally heated and cooled insulated concrete building that includes a continuous layer of foamed insulation within the exterior walls. The building is constructed of reinforced concrete having an outer and inner layer connected together along a lower edge, and the walls are assembled at the job site and filled with foam insulation. The outer concrete wall is provided with air ducts, and damper and blower controls provide solar heating in cold weather by circulating air that has been warmed in the exterior ducts to the interior of the building, and provides air circulation cooling in hot weather.

U.S. Pat. No. 4,164,933 by Alosi discloses a passive solar collector comprising pre-cast concrete panels having serpentine-like passageways disposed near a surface of the panel. The panels are placed to collect radiant solar energy, such as by placement on a roof or fabrication into a fence. The interior walls of a residence can also be constructed using the concrete panels and a plumbing circuit can be utilized to flow heated liquid through the panels, whereby the interior walls are warmed and the radiant heat warms rooms within the residence.

U.S. Pat. No. 4,267,822 by Diamond discloses a solar energy system utilizing modular elements that are pre-cast from concrete and include passageways through which a fluid is circulated for the transfer of energy. The modular units can be utilized as structural wall members having an inner layer, and an outer layer and a layer of thermal insulation can be disposed between the inner and outer concrete layers. The outer layer functions as a solar collector and storage unit and the working fluid can be pumped from the outside layer to the inside layer to transmit heat into the room.

### SUMMARY OF THE INVENTION

There remains a need for an energy efficient system and method that are adapted to provide radiant heating and radiant cooling to the interior of a building structure. The system and method may be adapted to control the temperature within the building structure in a wide variety of climate conditions.

The present invention relates to a structural panel, a building structure incorporating a structural panel and a method of providing climate control within a building structure. According to one aspect, the panel is a concrete panel and comprises an inner concrete layer and an insulative outer layer. Conduits are formed in the inner concrete layer for the flow of a thermal transfer liquid through the inner concrete layer to provide heating or cooling of the inner concrete layer.

According to one embodiment, a system for integrated climate control of a building structure provided. The system may include a wall comprising at least one wall panel, the wall panel comprising a cementitious interior wall panel layer and a thermal insulation layer disposed between the cementitious interior wall panel layer and an exterior of the building structure. A fluid conduit may be disposed within the cementitious interior wall panel layer, the fluid conduit having an inlet port and an outlet port. The system also may include means for moving a thermal transfer liquid through the fluid conduit within the cementitious interior wall panel and means for controllably adjusting the temperature of the thermal transfer liquid by heating and cooling the thermal transfer liquid to a desired temperature.

According to one aspect, the means for adjusting the temperature of the thermal transfer liquid comprises means for solar heating of the thermal transfer liquid. According to another aspect, the means for adjusting the temperature of the thermal transfer liquid comprises an evaporative cooler for cooling the thermal transfer liquid. According to another aspect, the at least one wall panel is in fluid communication with a second wall panel whereby the thermal transfer liquid can move from the first wall panel to the second wall panel. According to another aspect, the system further includes at least a first ceiling panel having fluid conduits, wherein the ceiling panel fluid conduits are in fluid communication with the temperature adjusting means.

According to yet another aspect, the interior wall panel layer is a concrete layer, such as one having a thickness of at least about 3 inches. According to another aspect, the thermal insulation layer may comprise a closed cell foam.

According to another embodiment, a method for controlling the temperature of the interior of a building structure is provided. The method may include the steps of detecting the temperature of an interior portion of the building and/or a thermal transfer fluid, controllably adjusting the temperature of the thermal transfer liquid in response to the detecting and moving the temperature adjusted thermal transfer liquid through at least a first sidewall panel, the first sidewall panel comprising an interior wall panel layer and a fluid conduit disposed within the interior wall panel layer.

According to one aspect, the thermal transfer fluid is a water-based fluid. according to another aspect, the step of adjusting the temperature of the thermal transfer fluid comprises actively heating the water-based thermal transfer fluid. According to another aspect, the step of adjusting the temperature of the thermal transfer fluid comprises actively cooling the water-based thermal transfer fluid.

The systems and methods described herein do not require the use of fans or blowers and may be much quieter than forced air systems. The systems and methods may also insure indoor air quality by minimizing the potential for bacteria, mold, dust and allergens from circulating through the air. Further, the walls may be resistant to attack by moisture. It is a particular advantage that the systems and methods may provide both heating and cooling in a highly efficient manner.

### DESCRIPTION OF THE DRAWINGS

FIG. 1 illustrates a perspective view of a unitary structural panel that is useful for fabricating a wall of a building according to an embodiment of the present invention.

FIG. 2 illustrates a cross-sectional side view of a unitary structural panel that is useful for fabricating a wall of a building according to an embodiment of the present invention.

FIG. 3 illustrates a cross-sectional front view of a unitary structural panel that is useful for fabricating a wall of a building according to an embodiment of the present invention.

FIG. 4 illustrates a cross-sectional top view of a unitary structural panel that is useful for fabricating a wall of a building according to an embodiment of the present invention.

FIG. 5 illustrates a perspective view of a unitary structural panel including an aperture that is useful for fabricating a wall of a building according to an embodiment of the present invention.

FIG. 6 illustrates multiple unitary structural panels that are interconnected to form a building wall in accordance with an embodiment of the present invention.

FIG. 7 illustrates a schematic of a heating and cooling system incorporating structural wall panels according to an embodiment of the present invention.

FIG. 8 schematically illustrates a building structure having a climate control system according to an embodiment of the present invention.

### DESCRIPTION OF THE INVENTION

The present invention relates to systems and methods for efficiently controlling the climate, e.g., the temperature, within a building having an enclosed space, such as a personal residence or a commercial building structure, including multi-level building structures such as high-rise structures. In particular, the present invention relates to structural panels that can be used for the walls and/or ceilings of a building, where the panels include one or more fluid conduits for the passage of a thermal transfer fluid through the panel. The panels advantageously provide an efficient means for heating and cooling a building interior to maintain a comfortable climate within the building interior.

According to one embodiment, a building structure includes exterior walls and a roof defining an enclosed space. At least a portion of the exterior walls may be fabricated from a structural panel that includes an inner cementitious layer and a thermal insulation layer disposed between the inner cementitious layer and the exterior of the building structure. A fluid conduit is provided within the inner cementitious wall panel layer, where the conduit is adapted to contain a thermal transfer fluid, such as liquid water and permit movement of the thermal transfer fluid through the inner cementitious layer. By controlling the temperature of the thermal transfer fluid, the climate (e.g., the temperature) within the interior of the building can be controlled by heating and/or cooling of the fluid to a desired temperature. A high thermal efficiency can be realized due, in part, to the high thermal mass of the inner cementitious wall. That is, the cementitious wall can continue to radiate warmth or absorb heat for an extended period of time after the temperature of the cementitious wall is adjusted. The thermally insulative layer may advantageously reduce thermal losses from the inner wall to the exterior of the building.

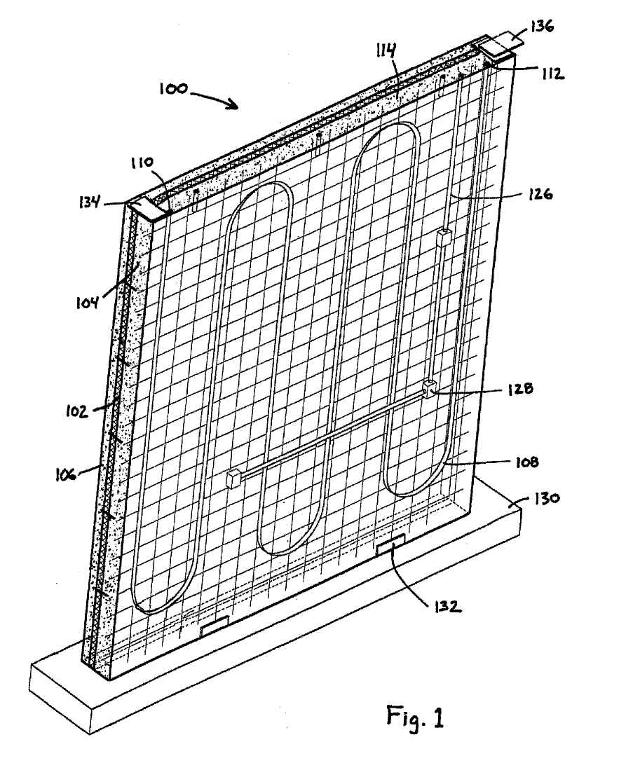

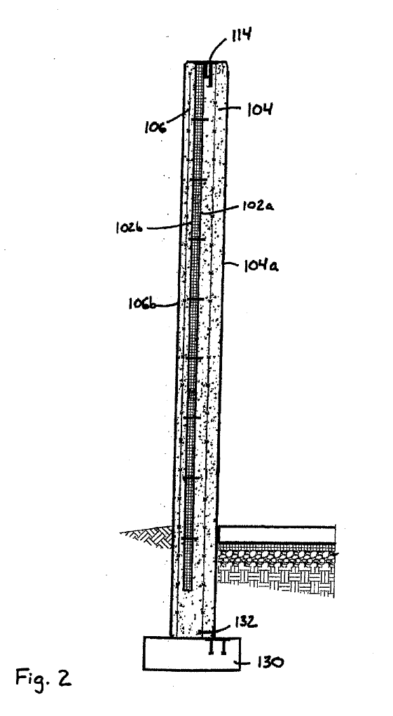

Referring to FIG. 1 and FIG. 2, a structural panel according to one embodiment of the present invention is illustrated. The structural panel 100 includes a thermal insulation layer 102 having a first major surface 102a and a mutually opposed second major surface 102b. A first (interior) concrete layer 104 is disposed adjacent to the first (inner) surface 102a of the thermal insulation layer 102, wherein the first concrete layer 104 includes a fluid conduit 108 disposed within the first concrete layer 104 that is adapted to store and/or convey a thermal transfer fluid through the first concrete layer. A second (exterior) concrete layer 106 or other exterior surface finish may be disposed adjacent to the second (outer) major surface 102b of the thermal insulation layer 102. The second concrete layer 106 may be substantially solid, and in particular it is preferred that the second concrete layer 106 not include fluid conduits therethrough and that the second concrete layer 106 is not in fluid communication with the conduit 108 in the first concrete layer 104, such that thermal transfer fluid is moved solely through the first concrete layer 104 without being moved through the second concrete layer 106. This ensures that the heating or cooling affect of the thermal transfer fluid is applied only to the interior portion of the panel and the temperature of the thermal transfer fluid is not affected by the temperature of the exterior of the building structure. In any event, the exterior of the structural panel 100 may include, for example, a stucco finish placed adjacent to the outer surface 102b or other non-functional and aesthetically acceptable surface treatment such as conventional siding over the thermal insulation layer 102 in place of the second concrete layer 106 or in addition to the second concrete layer 106.

The thermal insulation layer 102 is adapted to enhance the thermal resistance (e.g., the R-value) of the structural panel 100, and in that regard may have a higher thermal resistance than the concrete layer 104. While the first concrete layer 104 advantageously has a large thermal mass, the thermal resistance of concrete is relatively low, and therefore thermal transfer can cause the temperature of the interior wall surface 104a to equilibrate with the exterior temperature in a short period of time. Accordingly, the thermal insulation layer 102 may be selected to have a thermal resistance that is greater than the thermal resistance of the concrete layer 104, and preferably the thermal insulation layer has a thermal resistance of at least about R-10, more preferably at least about R-15. A variety of materials can be used for the thermal insulation layer 102, and in one embodiment the insulation layer is fabricated from closed cell foam. For example, the thermal insulation layer 102 can include closed cell foam, such as the polystyrene closed cell foam available under the trademark STYROFOAM from the Dow Chemical Company. Closed cell foams of this type are structurally rigid, have good thermal resistance and are resistant to attack by moisture.

According to another embodiment, the thermal insulation layer 102 may comprise a natural product, or a natural product derivative that is not derived from petrochemicals. For example, soy insulation, cellulose-based insulation, wheat straw or similar natural thermal insulation products can be used. Other materials having a high thermal resistance value may be used.

The thermal insulation layer 102 should have a thickness that is sufficient to provide good insulative properties to the structural panel 100 without significantly compromising the structural strength of the panel 100. The thickness of the thermal insulation layer 102 may vary depending upon the material used. According to one embodiment, the thermal insulation layer may have a thickness of at least about ½ inch (1.3 cm), such as at least about 1 inch (2.5 cm), and may have a thickness that is not greater than about 6 inches (15.2 cm), such as not greater than about 3 inches (7.6 cm). Such thickness ranges are particularly applicable to closed cell foam materials such as polystyrene.

The first (interior) concrete layer 104 and a second (exterior) layer 106, if any, are disposed on opposite sides of the thermal insulation layer 102. As used herein, the invention is described using the term concrete for the interior layer. Concrete refers to any cementitious material, and can include aggregates in addition to the cementitious material. The cementitious material can be, for example, Portland cement or can include materials such as pozzolans, fly ash or blast furnace slag. In addition, the interior layer may be comprised of other high thermal mass materials, such as clay (e.g., adobe clay) or rammed earth (e.g., compacted dirt).

The first concrete layer 104, which in the construction of a building is disposed facing the interior portion of the building, includes a fluid conduit 108 disposed within the concrete layer 104, where the conduit 108 is adapted to convey a thermal transfer liquid through the first concrete layer 104. The conduit preferably has a substantially circular cross-section to facilitate the flow of a liquid through the conduit. In this regard, the conduit may have a diameter of at least about ⅜ inch (0.95 cm), such as at least about ½ inch (1.3 cm), and not greater than about 2 inches (5.1 cm), such as not greater than about 0.75 inch (1.9 cm).

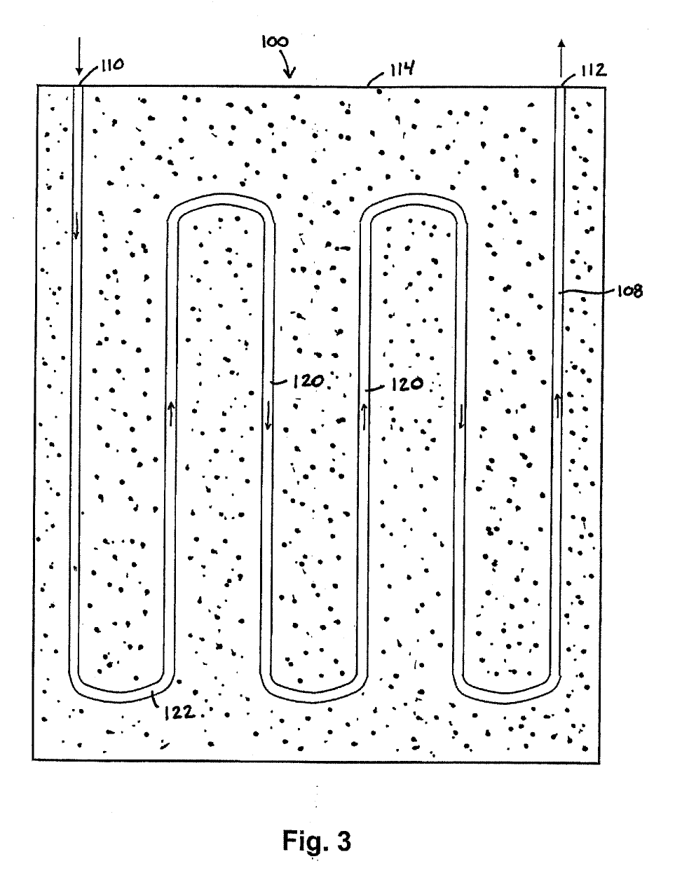

As is more clearly illustrated in the cross-sectional view of FIG. 3, the conduit 108 may have a serpentine-like configuration to enhance the evenness of the heat transfer from the thermal transfer fluid to the interior surface 104a of the inner concrete layer 104. In the configuration illustrated in FIG. 3, a thermal transfer fluid is injected into the conduit through an inlet port 110 and initially moves generally downwardly through the panel 100. A rounded portion 122 of the conduit 108 causes the fluid to then flow generally upwardly through the panel. This change in direction of fluid flow can occur one or several times depending upon the width of the panel 100. Preferably, the conduit 108 includes generally linear portions 120 that are disposed in substantially parallel relation to adjacent linear portions. After traversing the panel 100 in this manner, the thermal transfer fluid may be withdrawn through an outlet port 112. It is preferred that the conduit 108 comprise a single flow channel to maintain essentially plug flow conditions for the thermal transfer fluid through the conduit 108. Preferably, the conduit 108 comprises tubing disposed through the first concrete layer 104, such as metal tubing (e.g., copper) or plastic tubing. Composite tubing can also be utilized, including tubing having an exterior metal surface and an interior plastic surface.

The linear portions 120 (e.g., the substantially vertical portions) of the conduit may be sufficiently spaced apart to retain structural integrity of the panel and spaced sufficiently close together to provide adequate thermal transfer (heating and cooling) to the interior space of a building structure. Accordingly, in one embodiment the conduit 108 is disposed in the first concrete layer 104 such that at least the adjacent linear portions of the conduit are disposed in substantially parallel relation, and such linear portions of the adjacent conduits are spaced apart (i.e., center-to-center) by at least about 2 inches (about 5.1 cm), such as at least about 6 inches (about 15.2 cm). However, to provide for adequate heating or cooling of the first concrete layer 104, the conduits are preferably spaced by not greater than about 36 inches (about 91 cm), such as by not greater than about 30 inches (about 76 cm).

According to the present invention, it is preferred that the first (interior) concrete layer 104 has a thickness that is greater than the thickness of the second (exterior) concrete layer 106, where such an exterior concrete layer is utilized. In one embodiment the first concrete layer 104 has a thickness that is at least about 1.5 times, such as at least about 2 times, greater than the thickness of the second concrete layer 106. It is an advantage of this aspect of the present invention that the thermal mass of the first concrete layer 104 is greater than the thermal mass of the second concrete layer 106 by virtue of an increased thickness. The high thermal mass of the first concrete layer 104 and the insulating affect of the thermal insulation layer 102 increase the heating and cooling efficiency of the panel by maximizing the capacity of the first concrete layer to maintain its thermal state over an extended period of time.

In this regard, the first concrete layer 104 is sufficiently thick to accommodate the conduits and to provide a sufficient thermal mass to provide efficient heating and cooling to the building interior. Accordingly, the first concrete layer preferably has a thickness of at least about 3 inches (about 7.6 cm), such as at least about 4 inches (about 10.2 cm), or at least about 5 inches (about 15.2 cm). However, the thickness of the first concrete layer 104 is preferably not greater than about 12 inches (30.5 cm), such as not greater than about 10 inches (25.4 cm). Further, the fluid conduit can advantageously be disposed about one-half way through the thickness of the first concrete layer 104, or can be disposed closer to the interior surface 104a.

The exterior of the panel 100 may include a second concrete layer 106 that is preferably substantially solid, and in particular that does not include conduits of a similar nature as those in the first concrete layer 104. As is noted above, the second concrete layer 106 preferably has a thickness that is less than the thickness of the interior concrete layer 104. Accordingly, in one embodiment the second concrete layer 106 has a thickness of at least about 2 inches (about 5.1 cm), such as at least about 3 inches (about 7.6 cm). Preferably, the thickness is not greater than about 6 inches (about 15.2 cm), such as not greater than about 5 inches (about 12.7 cm). However, as is noted above, such an outer concrete layer may omitted from the structure of the panel 100 without substantially affecting the heating and cooling performance of the panel 100.

Accordingly, the unitary structural panel 100 may have a total thickness of at least about 6 inches (about 15 cm), more preferably at least about 8 inches (about 20 cm), and the thickness is preferably not greater than about 14 inches (about 36 cm), such as not greater than about 12 inches (about 31 cm).

The dimensions (height and width) of the panel 100 can be sized to accommodate a variety of building structures. For example, the panels can be substantially square with sides having a length of at least about 4 feet (about 1.2 meters) and not greater than about 12 feet (about 3.7 meters). The panels can also be of other rectangular configurations, such as panels having a width of from about 4 feet (about 1.2 meters) to about 14 feet (about 4.3 meters) and a height that is 10 feet (about 3.0 meters), 12 feet (about 3.7 meters) or even higher.

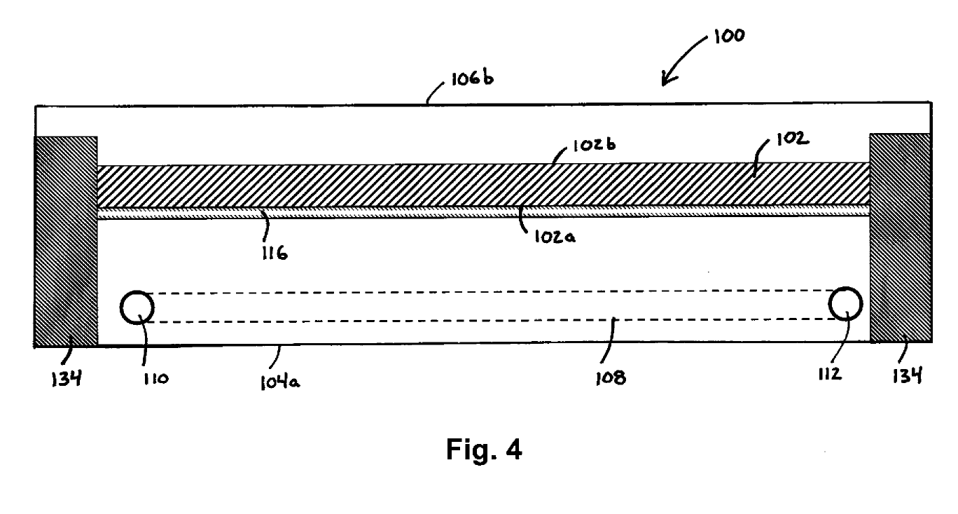

According to one embodiment, and as illustrated in the cross-sectional top view of FIG. 4, the structural panel 100 may optionally include a metallic layer 116 disposed between the thermal insulation layer 102 and the first concrete layer 104. The metallic layer 116 may be adapted to reflect thermal radiation back to the first concrete layer 104, thereby improving the thermal efficiency of the panel 100. For example, the metallic layer 116 may be a thin metal sheet, such as an aluminum sheet, adjoining the first major surface 102a thermal insulation layer 102. The metallic layer 116 may be thin, and in one embodiment has a thickness of not greater than about 0.5 inch (about 1.3 cm). A second metallic layer (not illustrated) may also be provided between the second major surface 102b of the insulative layer 102 and a second concrete layer 106 to reflect thermal radiation back to the exterior of the panel 100.

During fabrication of the structural panel 100, the metallic layer 116 can be chemically attacked by the cementitious material of the first concrete layer 104 before the cementitious material fully sets. Therefore, a protective barrier layer (not illustrated) may advantageously be disposed between the metallic layer 116 and the first concrete layer 104 to reduce or prevent such degradation. As an example, a thin layer of plastic may be disposed between the first concrete layer 104 and the metallic layer 116. Also, an additional thin layer of thermal insulation such as closed cell foam may be provided between the reflective layer 116 and the first concrete layer 104.

Referring back to FIG. 1, during construction of a building structure, the panel 100 may be mounted to form a portion of a wall unit by mounting the panel 100 onto a footer 130. For example, the panel 100 may be attached to the footer 130 by welding embedded metal plates 132 to corresponding metal plates on the footer 130. Further, top metal plates 134 can be attached on a top edge 114 of the panel such that adjacent panels can be connected along the top edge 114 by welding to a connector plate 136. As is known to those skilled in the art, after securing the panels to the footer 130 and to adjacent panels, any gaps or seams can be sealed to prevent ingress and egress of moisture and air. As is discussed in more detail below, the panel may also be “poured-in-place” as opposed to being pre-fabricated and positioned onto the footer.

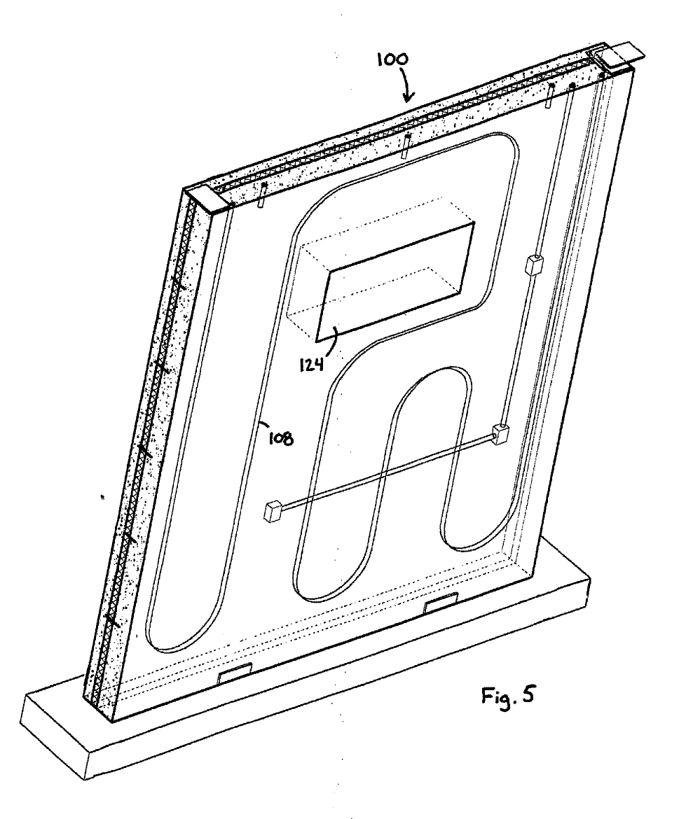

In addition, the panel 100 may be provided with utility conduits 126 and utility boxes 128 for the placement of electrical and telecommunications wiring, as is illustrated in FIG. 5. In the embodiment illustrated in FIG. 5, the panel 100 also includes an aperture 124 that is adapted for the placement of a window or similar structure in the panel. In this regard, the fluid conduit 108 can be placed around the aperture 124 to evenly control the temperature of the first concrete layer 104.

Structural panels in accordance with the foregoing description may be produced in the following manner. A form having borders, such as a wooden form, may be provided in the desired size and shape of the panel. When needed, an exterior concrete portion of the structural panel may be formed by pouring wet concrete into the form to the desired depth, such as about 3 inches (7.6 cm). Thereafter, a thermally insulative material may be placed over the poured concrete layer. Preferably, the thermally insulative material is placed over the poured concrete when the poured concrete is still wet and has not completely dried. Fastening means, such as structural ties may be used to affix the thermally insulative material to the exterior concrete layer, if necessary. The thermally insulative material may also have a metallic reflective layer pre-attached to the thermally insulative material.

The fluid conduit tubing may be supported by being placed on rebar (when used in the concrete layer), mesh or a similar supporting material. For example. wire mesh can be utilized to support the tubing that will comprise the fluid conduit. In this regard, a plurality of supports can be placed on the insulative material to support the wire mesh. The height of these supports will determine the depth of the conduit within the interior concrete layer. According to one embodiment, the supports have a height that will place the conduit at a distance about one-half way through the first (interior) concrete layer.

After placement of the supports on the thermal insulation, the wire mesh may be placed on the supports. To form the fluid conduit, tubing, such as tubing having an outer diameter of from about 0.5 inch to about 0.75 inch, may be attached to the wire mesh in a desired configuration such as a serpentine configuration. The tubing may be attached to the wire mesh prior to placement of the mesh onto the supports or after the wire mesh is placed onto the supports. The tubing may be metallic tubing such as copper, or may be plastic tubing. Composite tubing may also be utilized, such as that sold under the tradename KiTEC available from KiTEC Industries (India) Limited. KiTEC is an aluminum and polyethylene composite where the polyethylene layer is disposed on the inner diameter of the tubing. The composite tubing combines the features of both materials to form a pipe that is light, strong and does not support corrosion. By combining the two materials, composite tubing avoids the thermal expansion and deformation of plastic pipe, and at the same time it retains the flexibility, frost resistance and ease of use associated with plastic.

In addition to the tubing utilized to form the thermal transfer fluid conduit, conduits for electrical wiring through the interior concrete layer may be formed by attaching tubing materials to the wire mesh. Boxes for electrical outlets and similar access ports can be provided extending from the tubing such that the access ports form in the concrete layer when the concrete is poured.

Further, metal connection plates may be provided when needed on the upper and lower peripheral edges of the panel to enable the panel to be welded to adjacent panels and also to be welded to a supporting footer during construction of the building.

After pouring of the interior concrete layer, the panel may be allowed to dry and is then ready for installation. The panels may be pre-fabricated in such a manner and shipped to the construction site. However, pre-fabrication and shipping may limit the size of the panel due to the limitations of available transportation vehicles. In this regard, the panels may be fabricated on-site. After fabrication, the panels may be placed into position, such as by using a crane to move and tilt the panels into the upright (vertical) position. For example, all of the panels needed for a building may be fabricated on-site, and then a crane may be used to efficiently move and place the panels into position.

Further, the panels may be poured and dried in place during fabrication of the building structure. That is, a panel may be formed by pouring the concrete into a mold containing the tubing for the fluid conduits and other elements, in a similar manner as is described above, where the mold has been fixed into the desired position of the wall. Such a pour-in-place technique can be particularly advantageous for the fabrication of large panels as a single unit, where tilt-up placement of the panel would be difficult. In this regard, the thermal insulation layer may be incorporated directly into the mold, or can be attached to the concrete after drying.

The present invention is also directed to a building structure and climate control system that include a wall unit fabricated using one or more structural panels, such as those described above.

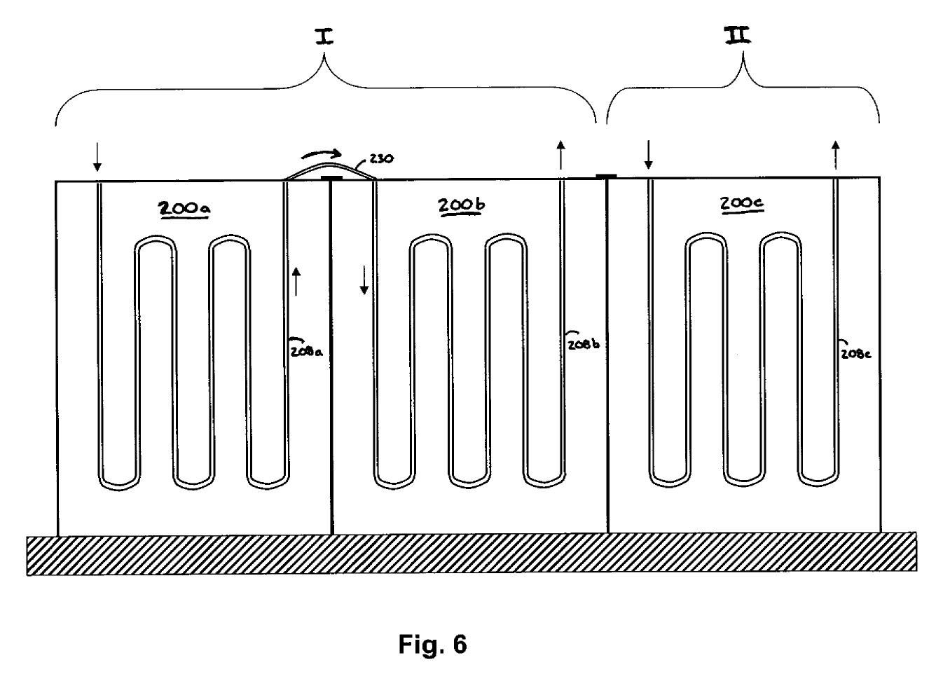

For example, FIG. 6 illustrates three structural wall panels 200a, 200b and 200c that are interconnected to form a wall unit. In this regard, the fluid conduit 208a of panel 200a and the fluid conduit 208b of panel 200b are interconnected by fluid connection 230 such that the thermal transfer fluid may flow into panel 200a and then through panel 200b before being transferred out of the panels for adjusting (raising or lowering) the temperature of the thermal transfer fluid for eventual return to the panels. Thus, panels 200a and 200b define a first temperature zone (Zone I). A second zone (Zone II) includes panel 200c where a thermal transfer fluid is passed through the conduit 208c and is then removed to have the temperature of the fluid adjusted. Zone I and Zone II may be operated independently depending on the desired heating or cooling requirements of the interior. In this regard, the structural panels of the present invention may advantageously enable panels to be interconnected to form a single climate zone, or to be operated independently to form multiple climate zones. For example, the cooling requirements for structural walls disposed on the southern-facing side of a building may be higher than those disposed on the northern-facing side of the building.

The present invention is also directed to a system and method for regulating the climate, particularly the temperature, within the interior of a building. The building may include substantially vertical sidewalls having an interior surface facing the interior of the building and an exterior surface disposed on the exterior of the building. A thermal transfer fluid, such as water, may be moved through the walls near the interior surface of the walls to provide heating or cooling to the interior of the building structure.

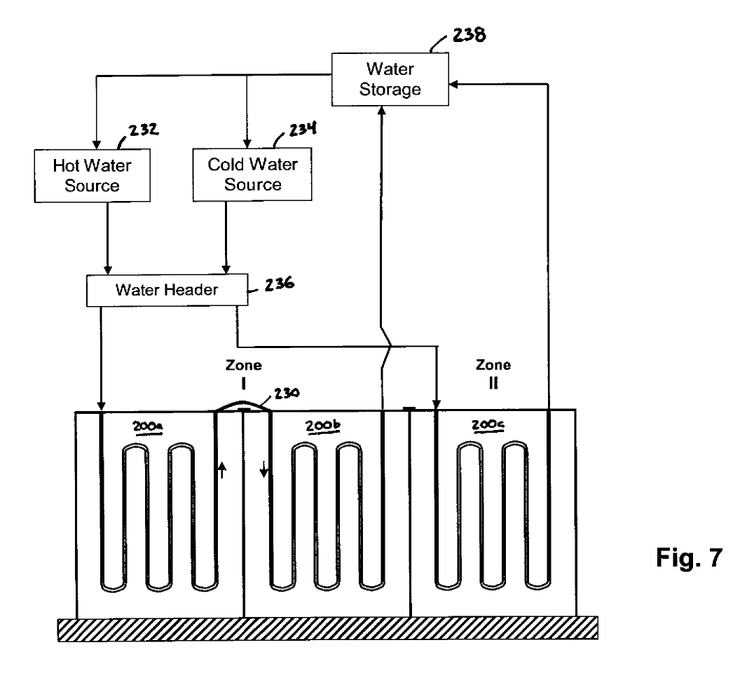

FIG. 7 schematically illustrates a portion of a system for climate control of a building structure by heating and cooling according to an embodiment of the present invention. This system includes panels 200a, 200b and 200c as is described above. A hot water source 232 and a cold water source 234 are connected to a water header 236, where the water header 236 controls the flow of water to the panels within the system. The water header 236, as well as the hot water source 232 and the cold water source 234, may be connected to one or more thermostats, which detect the interior temperature and send signals to the hot water source 232 and/or cold water source 234 to control the water temperature and/or water flow rates to various zones within the system. In addition to, or in lieu of, a thermostat to detect the interior temperature, one or more temperature sensors can be used to detect the temperature of the water within the panels or at another point in the system outside of the hot water source or cold water source, such as immediately after the water has been passed through the panels. In this manner, the sensor(s) can determine the temperature change of the water within the panels, and thereby determine the amount of heating or cooling of the water that should occur before being recirculated to the panels to maintain a pre-determined set point interior temperature.

Thus, as is illustrated in FIG. 7, the water header 236 can provide hot or cold water to either of Zone I or Zone II depending on the heating and cooling requirements. Although illustrated as two separate units, it will be appreciated that a single unit or device may function as both a hot water source and a cold water source.

Pumps (not illustrated) may provide sufficient pressure to move the water through the panels and maintain adequate fluid circulation within the system. Although the bulk of the water may be stored within the panel conduits and/or within the hot or cold water sources, an optional water storage unit 238 may also be utilized to store a portion of the water. The water may also include additives, for example anti-freeze agents such as glycol to reduce the freezing point of the water. Other fluids, including phase change materials, may also be used as the thermal transfer liquid.

The hot water source may include a traditional active hot water boiler having a storage tank, including one that is heated by electricity or gas or by other means such as a wood-fired or biomass-fired boiler. The hot water source 232 may also be an “instant”, or on-demand, hot water heater that does not include a storage tank for the temporary storage of the hot water. The hot water heater may optionally be powered in whole or in part, for example, using photovoltaics or other solar means to enhance the energy efficiency of the system. The water can also be passively heated using solar panels, such as solar panels disposed on a roof of the building. A solar-based device (e.g., active or passive solar) may be used to pre-heat water before the water is provided to the hot water heater for final heating. Geothermal loops may also be used for heating of the water. Heating of the water can also be supplemented using phase change materials.

According to the present invention, the system may also include a cold water source 234 to provide cooling to the interior of the building when needed. The cold water source 234 may include a geothermal loop, for example, to cool water by passing the water through channels buried within the ground beneath or near the building. Other cold water sources, such as mechanical refrigeration units, can also be used to cool the water. Evaporative cooling units may be particularly advantageous for cooling of the water, particularly in arid environments. Night Sky Radiant Cooling (NSRC) solar panels, which are typically unglazed solar panels, may also be advantageously utilized to cool the water, even in hot desert environments. Such solar panels may advantageously be able to provide both cooling and heating of the water in a single unit, depending upon the time of the day and the climate. Other cold water sources can include a ground source heat pump, for example.

Thus, the structural panels and heating and cooling systems of the present invention advantageously provide an economical and environmentally friendly means for heating and cooling the interior of a building. Specifically, it has been found that the use of a thermal transfer fluid such as water to heat and cool the interior surface of the relatively large thermal mass interior wall can efficiently heat and cool a building interior.

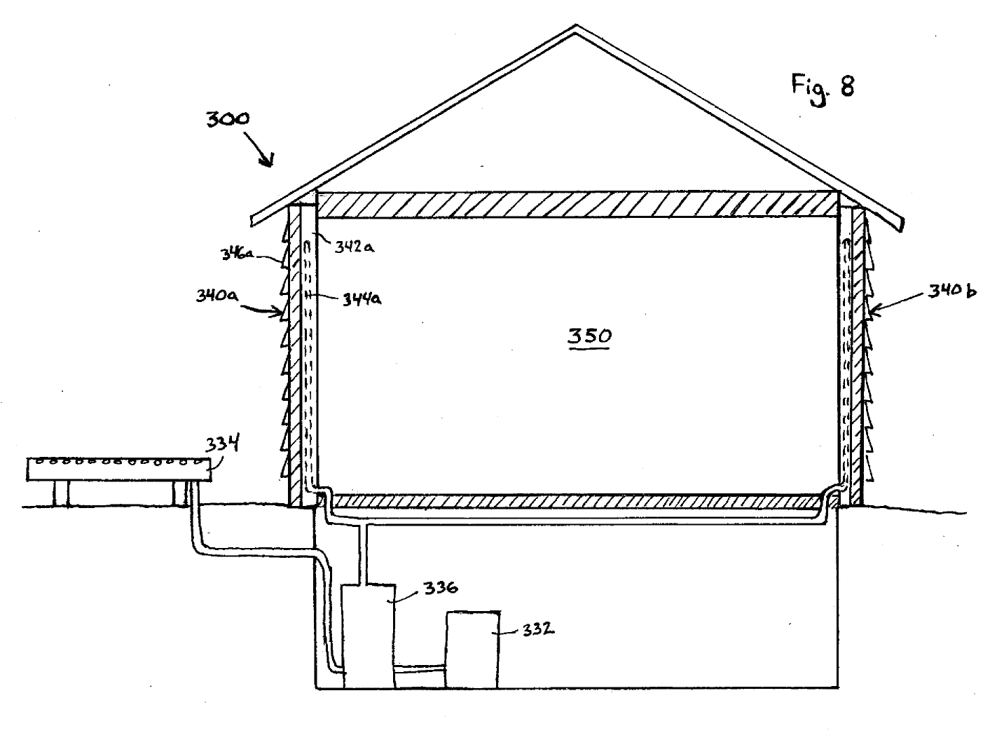

FIG. 8 schematically illustrates an exemplary embodiment of a building 300 incorporating a climate control system in accordance with the foregoing. The building 300 includes sidewalls 340a and 340b partially defining an interior 350. With reference to sidewall 340a, the sidewall 340a includes an interior wall panel layer 342a having a fluid conduit 344a therethrough. A thermal insulation layer 346a is disposed between the interior wall panel layer 342a and the exterior of the building 300. Conventional siding 346a is provided on the exterior surface of the thermal insulation layer 346a.

The fluid conduit 344a in the interior wall panel layer 342a is fluidly connected to a water header 336. As illustrated in FIG. 8, the water header 336 is fluidly connected to a hot water boiler 332 for heating of the water, and to a night sky radiant cooling device 334 for cooling of the water. As is discussed above, other heating and cooling means can be used in addition to, or in lieu of, these devices. The flow of the water can be controlled using pumps (not illustrated) to move the water through the system.

While various embodiments of the present invention have been described in detail, it is apparent that modifications and adaptations of those embodiments will occur to those skilled in the art. However, is to be expressly understood that such modifications and adaptations are within the spirit and scope of the present invention.

What is claimed is:

1. A system for integrated climate control of a building structure, comprising:
a wall comprising at least one wall panel, the wall panel comprising a cementitious interior wall panel layer and a thermal insulation layer disposed between the cementitious interior wall panel layer and an exterior of the building structure;
a fluid conduit disposed within the cementitious interior wall panel layer, the fluid conduit having an inlet port and an outlet port;
means for moving a thermal transfer liquid through the fluid conduit within the cementitious interior wall panel; and
means for controllably adjusting the temperature of the thermal transfer liquid by heating and cooling the thermal transfer liquid to a desired temperature.

2. A system as recited in claim 1, wherein the means for adjusting the temperature of the thermal transfer liquid comprises means for solar heating of the thermal transfer liquid.

3. A system as recited in claim 1, wherein the means for adjusting the temperature of the thermal transfer liquid comprises an evaporative cooler for cooling the thermal transfer liquid.

4. A system as recited in claim 1, wherein at the least one wall panel is in fluid communication with a second wall panel whereby the thermal transfer liquid can move from the first wall panel to the second wall panel.

5. A system as recited in claim 1, further comprising at least a first ceiling panel having fluid conduits, wherein the ceiling panel fluid conduits are in fluid communication with the temperature adjusting means.

6. A system as recited in claim 1, wherein the interior wall panel layer is a concrete layer.

7. A system as recited in claim 1, wherein the cementitious interior wall panel layer has a thickness of at least about 4 inches.

8. A system as recited in claim 1, wherein the thermal insulation layer comprises a closed cell foam.

9. A method for controlling the temperature of the interior of a building structure, comprising the steps of:
detecting the temperature of at least one of a thermal transfer liquid and an interior portion of the building;
controllably adjusting the temperature of a thermal transfer liquid in response to the detecting; and
moving the temperature adjusted thermal transfer liquid through at least a first sidewall panel comprising an interior wall panel layer and a fluid conduit disposed within the interior wall panel layer.

10. A method as recited in claim 9, wherein the thermal transfer fluid is a water-based fluid.

11. A method as recited in claim 9, wherein the step of adjusting the temperature of the thermal transfer fluid comprises actively heating the water-based thermal transfer fluid.

12. A method as recited in claim 9, wherein the step of adjusting the temperature of the thermal transfer fluid comprises cooling the water-based thermal transfer fluid.

13. A method as recited in claim 9, wherein the detecting step comprises detecting the temperature of an interior portion of the building.

14. A method as recited in claim 9, wherein the detecting step comprises detecting a temperature of the thermal transfer fluid.
